(19) United States
(12) Patent Application Publication
(10) Pub. No.: US 2014/0090084 A1
(43) Pub. Date: Mar. 27, 2014

(54) COLLABORATIVE COMIC CREATION

(71) Applicant: Clive Goodinson, Parksville (CA)

(72) Inventor: Clive Goodinson, Parksville (CA)

(73) Assignee: Pixton Comics Inc., Parksville (CA)

(21) Appl. No.: 13/627,242

(22) Filed: Sep. 26, 2012

(30) Foreign Application Priority Data
Sep. 25, 2012 (CA) 2791110

(51) Int. Cl. G06F 21/24

(52) U.S. Cl. 726/28

(57) ABSTRACT

System and method for collaborative comic creation and editing by a plurality of users. Users may access the comic from a central server (aka shared data center) over the internet. When a user begins to make a change to a selected object in the comic, a momentary object lock may be generated and propagated to the other users to prevent them from making conflicting changes to the object. Modified comic data defining the change may then be sent from the user's computer to the central server for storage and propagation to the other users to update the comic at the user terminals and the central server. Each user may have a set of editing privileges which define the comic data the user may change. A permanent lock may be generated for each user and applied against the comic data that the user is not entitled to change.

### CROSS-REFERENCE TO RELATED APPLICATIONS

This application claims priority from Canadian patent application number not yet available, filed on Sep. 25, 2012.

### BACKGROUND

(a) Field

The subject matter disclosed generally relates to a system which allows multiple users to collaborate in creating a comic over the internet.

(b) Related Prior Art

There exists in the market websites that allow users to create a comic and save it at the server associated with the website or download it and save it locally on a computing device for future editing or otherwise.

There are also websites which allow multiple users to collaborate on editing a document. An example includes Google Docs which allows multiple users to collaborate on documents such as spreadsheets, text, drawings, presentations etc.

These websites cannot be used for collaborative editing and creation of comics. In particular, the synchronization of modifications in this type of document is prone to conflicts and chaos because each change gets saved and when conflicting changes are performed the last change gets saved overriding the previous change and not giving the other users the chance to review, approve and modify what each collaborative user is proposing. The situation becomes worse when the number of users increases.

This is frustrating to the users especially when more people collaborate on the same comic.

Therefore, there is a need in the market for an efficient system for collaborative comic creation and editing which allows multiple users to have access to the comic and edit it without conflicts or synchronization problems.

The present embodiments propose such a system.

### SUMMARY

According to first aspect, there is provided a method for collaborative creation and editing of a comic by users, each one of the users using a computing device to access the comic from a central server over a communication network, the comic comprising one or more panels and each panel comprising one or more assets, the method comprising: assigning a set of editing privileges to each user, the editing privileges defining comic data that the user is entitled to modify; generating, for each one of the users, a permanent lock on comic data outside of their editing privileges, to prevent unauthorized users from editing comic data that they are not entitled to; receiving, from a given user, an indication that the given user initiated a change to a selected object in one of the one or more panels; in response to the receiving, generating a momentary lock on the selected object, and propagating the momentary lock to all users having editing privileges that overlap with the editing privileges of the given user; receiving modified comic data defining the change to the selected object, and updating the comic on the central server to include the change; propagating the modified comic data to remaining ones of the users to display the change to all users; and removing the momentary lock after the change is done.

In an embodiment, the method may further include applying the momentary lock only in the one or more panels that correspond to the panel in which the change is being performed by the given user, if the selected object defines panel specific properties.

In an embodiment, the method may further include applying the momentary lock in all the one or more panels of the comic, if the selected object defines global properties.

In an embodiment, the method may further include updating the comic to reflect the change only in the one or more panels that correspond to the panel in which the change is being performed by the given user, if the selected object defines panel specific properties.

In an embodiment, the method may further include updating the comic to reflect the change across all relevant panels of the comic, if the selected object defines global properties.

In an embodiment, the method may further include at the central server, detecting addition of a new asset by one of the users; obtaining global properties of the new asset from the user associated with the new asset; forwarding the global properties of the new asset to the remaining ones of the users for updating the comic on the computing device of each one of the users.

In an embodiment, the method may further include providing computer readable instructions for execution on the computing device of each one of the users upon login for displaying the comic on the computing device of each one of the users.

In an embodiment, the computer readable instructions cause the computing device to detect incorporation of a new asset into the comic and send global properties defining the new asset to the central server. The method further comprising: upon receiving the global properties defining the new asset from one user, forwarding the global properties of the new asset to the remaining ones of the users; and updating the comic centrally to add the new asset to the comic.

In an embodiment, the computer readable instructions cause the computing device to detect a new asset in comic data received from the central server, and notify the central server of data relating to the new asset, the method further comprising requesting global properties of the new asset from the user associated with the new asset; receiving the global properties at the central server; and forwarding the global properties of the new asset to the remaining ones of the users.

In an embodiment, the computer readable instructions are embedded in a web-browser installed on the computing device of each one of the users.

In another aspect, there is provided A server for collaborative creation and editing of a comic by users accessing the comic over a communication network, each one of the users using a computing device, the comic comprising one or more panels and each panel comprising one or more assets, the server comprising: a processor having access to statements and instructions which when executed cause the processor to assign to each user a set of editing privileges defining comic data that the user is entitled to modify, and generate for each one of the users a permanent lock on comic data outside of their editing privileges; a data input adapted to receive, from a given user, an indication that the given user initiated a change to a selected object in one of the one or more panels, and modified comic data defining the change to the selected object; wherein upon receiving the indication from the given user, the processor generates a momentary lock on the selected object; a data output adapted to propagate the momentary lock to all of the users having editing privileges that overlap with the editing privileges of the given user to prevent conflicting modifications of the selected object, and to propagate the modified comic data to remaining ones of the users to display the change to all users; and a memory for storing and updating the comic.

In an embodiment, the momentary lock is removed after the change is done.

In another embodiment, the editing privileges are grouped under roles, whereby users with different roles may work simultaneously on the same panel of the same comic.

In another embodiment, the momentary lock is applied only in panels that correspond to the panel in which the change is being performed by the given user, if the selected object defines panel specific properties.

In another embodiment, the momentary lock is applied in all the one or more panels of the comic, if the selected object defines global properties.

In another embodiment, the comic is updated to reflect the change only in the one or more panels that correspond to the panel in which the change is being performed by the given user, if the selected object defines panel specific properties.

In another embodiment, the comic is updated to reflect the change across all of the one or more panels of the comic, if the selected object defines global properties.

In another embodiment, the processor is adapted to detect an addition of a new asset by one of the users, obtain global properties of the new asset from the user associated with the new asset; and forward the global properties of the new asset to the remaining ones of the users for updating the comic on the computing device of each one of the users.

In another embodiment, the server is adapted to provide computer readable instructions for execution on the computing device of each one of the users for displaying and manipulating the comic on the computing device of each one of the users, wherein the computer readable instructions cause the computing device on which they are installed to detect incorporation of a new asset in one of the one or more panels, and send global properties defining the new asset from the computing device to the server.

In a further aspect, there is provided a method for collaborative creation and editing of a comic by users, each user using a computing device to access the comic from a central server over a communication network, the comic comprising one or more panels and each panel comprising one or more assets, the method comprising: receiving, from a given user, an indication that the given user initiated a change to a selected object in one of the one or more panels; in response to the receiving, generating a momentary lock on the selected object, and propagating the momentary lock to remaining ones of the users to prevent conflicting modifications of the selected object; if the selected object defines panel specific properties, configuring the momentary lock to apply only in panels that correspond to the panel in which the change was detected by the given user, otherwise, configuring the momentary lock to apply in all panels of every comic in which the object is included; receiving modified comic data defining the change to the selected object, and updating the comic on the central server to include the change; propagating the modified comic data to the remaining ones of the users to display the change to all users; and removing the momentary lock after the change is done.

The following terms are defined below:

Comic: a sequence of images. In the present embodiments, the images are created collaboratively by two or more people.

Panel: one image or frame in the sequence of images, or frames that make up a comic.

Author: a user who is collaborating on the comic. There could be many authors for the same comic.

Team: the group of authors collaborating on the comic.

Asset: any object that may be included in a panel, e.g. a character, speech bubble, prop, background, uploaded image, sound.

System: the software, user interface, assets, etc. provided to the authors to create the comic.

Global Properties: those properties of an asset that are shared across all panels and comics in which the asset is included, e.g. a character's hairstyle.

Panel-Specific Properties: those properties of an asset that may vary from panel to panel, e.g. the expression on a character's face.

System-Defined Asset: an asset whose global properties are set by a system administrator, e.g. a preset background.

Author-Defined Asset: an asset whose global properties are defined by a user, e.g. a prop set.

Role: the editing privileges of an author, e.g. an author with a “writer” role may only be permitted to edit text and speech bubbles.

Comic data: all of the data relevant to a comic, including data describing the comic, panels, assets, authors, team, etc.

Features and advantages of the subject matter hereof will become more apparent in light of the following detailed description of selected embodiments, as illustrated in the accompanying figures. As will be realized, the subject matter disclosed and claimed is capable of modifications in various respects, all without departing from the scope of the claims. Accordingly, the drawings and the description are to be regarded as illustrative in nature, and not as restrictive and the full scope of the subject matter is set forth in the claims.

### BRIEF DESCRIPTION OF THE DRAWINGS

Further features and advantages of the present disclosure will become apparent from the following detailed description, taken in combination with the appended drawings, in which:

FIG. 1 illustrates an example of a panel including a number of assets, in accordance with an embodiment;

FIG. 2 illustrates an example of a data structure in a collaborative comic, in accordance with an embodiment;

FIG. 3 illustrates the flow of data that occurs when a collaborator (user) loads a comic for editing;

FIGS. 4a and 4b illustrate the steps of a synchronization event generated following the changing of comic data by a user/collaborator, in accordance with an embodiment;

FIGS. 5a to 5d illustrate the synchronization steps of global properties of assets, in accordance with an embodiment;

FIGS. 6a to 6d illustrate the synchronization of object lock events between clients having overlapping and non-overlapping editing privileges;

FIG. 7 is a flowchart of a method for collaborative creation and editing of a comic by a plurality of users, in accordance with an embodiment;

FIG. 8 is a flowchart of another method for collaborative creation and editing of a comic by a plurality of users, in accordance with another embodiment;

FIG. 9 is an example of a networked environment, where embodiments may be implemented; and

FIG. 10 illustrates a block diagram of an example computing operating environment in which embodiments may be implemented.

It will be noted that throughout the appended drawings, like features are identified by like reference numerals.

### DETAILED DESCRIPTION

System and method for collaborative comic creation and editing by a plurality of users. Users may access the comic from a central server (aka shared data center) over the internet. An updated copy of the comic including the latest changes is always stored at the central server. When a user begins to make a change to a selected object in the comic, a momentary object lock may be generated and propagated to the other users to prevent them from making conflicting changes to the object. Modified comic data defining the change may then be sent from the user's computer to the central server for storage and propagation to the other users to update the comic at each user terminal as well as at the central server. In an embodiment, each user may have a set of editing privileges which define the comic data the user may change. A permanent lock may be generated for each user and applied against the comic data that the user is not entitled to change.

The present embodiments describe a system and method which allow users to collaborate over a communication network to create and edit a comic. Collaboration may occur synchronously or asynchronously. In both cases, some or all of the data associated with a comic must be synchronized among all authors in the team in order for multiple authors to collaborate on a comic. Preferably, the collaboration may occur synchronously, whereby multiple users may collaborate on the comic in real time. Changes performed by each user may be synchronized with a central server (aka shared data server), wherein a copy of the latest changes may always be stored. The changes may also be sent from the central server to the remaining users to update the comic on the computing device of all active users so that all users may view and collaborate on the same version of the comic. In an embodiment, the user may log into the system over the internet, and obtain a copy of the latest version of the comic to view and modify.

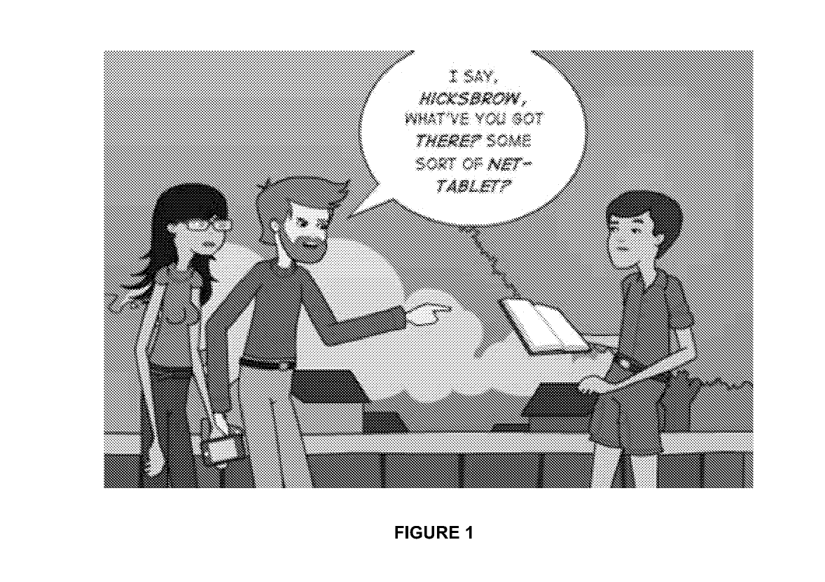

In an embodiment, the comic comprises a sequence of panels. An example of a panel is shown in FIG. 1. Each panel may contain any number of assets. In the example of FIG. 1, the assets may include the big tree on the right, the wall, the book held by the character on the right, the young woman, the background, the shrub to the left, the sky, the clouds etc.

In an embodiment, the data may exist at different levels of the comic. In an embodiment, the data may exist at the comic level, e.g. the title of the comic, the sequence of unique panel IDs etc. The data may also exist at the panel level, e.g. the identity and spatial configuration of assets that appear in the panel, properties of the panel's border etc.

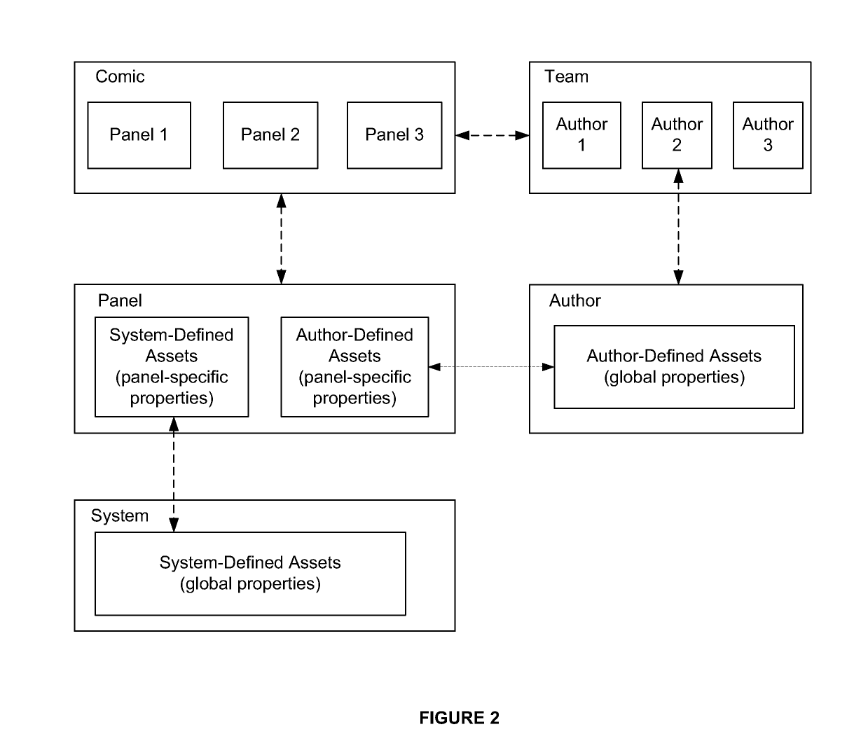

FIG. 2 illustrates an example of a data structure in a collaborative comic, in accordance with an embodiment.

In an embodiment, multiple authors could be associated with the comic. Data may exist at the team level, e.g. the team's name, a list of its members. Data may also exist at the author level, e.g. the author's screen name, the author's role(s). Furthermore, each author may have associated therewith the global properties of author-defined assets. For example, all of the characters the author has defined. Data may also exist at the system level e.g. the global properties of fixed assets, such as the shapes of various preset props.

In an embodiment, data describing the global properties of author-defined assets, such as a character's hairstyle, is stored in association with the author; whereas data describing panel-specific properties of author-defined assets, such as a character's facial expression, is stored in association with the panel. Similarly, data describing the global properties of fixed assets, such as the shape of a tree prop, is associated with the overall system; whereas data describing panel-specific properties of fixed assets, such as a tree prop's scale, is stored in association with the panel as shown in FIG. 2.

### Data Flow

In an embodiment, entities involved in the flow of data may include three kinds:

1. The client(s);

2. The shared data server(s);

3. The permanent database(s)

In the present context, the term “client” corresponds to an active collaborator's local device e.g. computing device. The term “Active” meaning that the collaborator is currently editing the comic. The “shared data server” stores all or some of the data that must be synchronized among the clients, and may or may not be permanent. The “permanent database” stores all of the data that is relevant to the comic. In an embodiment, the shared data server and the permanent database may and may not be one and the same.

Data is transmitted to the client from the shared data server or permanent database (collectively, “the server”), for one of two reasons:

1. The client has explicitly requested the data.

2. The data is being transmitted to the client in association with a synchronization event.

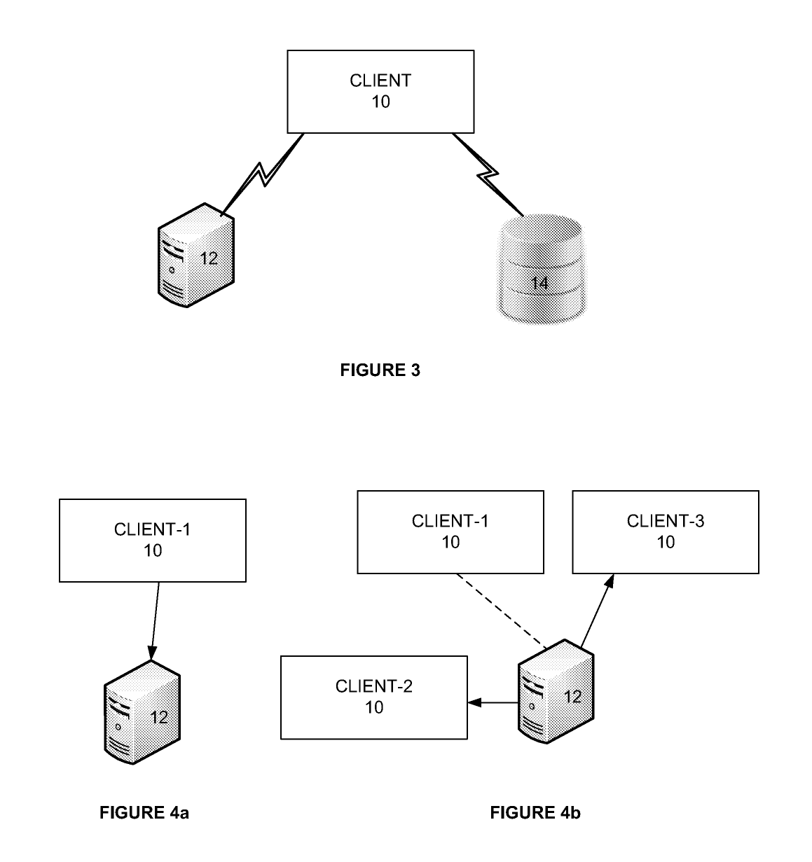

FIG. 3 illustrates the flow of data that occurs when a collaborator (user) loads a comic for editing. In an embodiment, the client 10 may first request the comic data from the shared data server 12. If no data is returned from the shared data server 12, the client 10 requests the data from the permanent database 14. In the embodiment where the shared data server 12 and the permanent database 14 are one, only one request for data is required.

In an embodiment, when the client 10 makes modifications in any part of the comic data e.g. the position of an asset, the addition of a prop to a panel, a synchronization event is automatically initiated as follows:
1. Data defining the change—the “change data”—is transmitted to the shared data server 12, as exemplified in FIG. 4a. The change may be defined as a transformation, e.g. “panel moved 10 pixels to the right”, or it may be defined as a new state, e.g. “panel positioned at (x=120, y=−10)”. The change data may correspond to a single state change, or it may correspond to multiple state changes.
2. The shared data server 12 transmits the change data to each client 10, as exemplified in FIG. 4b.
3. Each client 10 incorporates the change data into its local representation of the comic.

In an embodiment, the assets may include panel specific properties which may change between a panel and another e.g. position of a character, angle of rotation of an arm or leg or head etc., and global properties which when changed in one panel change automatically across the remaining panels e.g. shape of a character, hair color of a character etc. Accordingly, changes in panel specific properties ensure that the change is reflected only in the panel in which the change is done. When the change is synchronized to the other comics it would only appear in the panel that corresponds to the modified panel. In other words, if the user performs a panel specific property change in panel no. 3 of the comic, the comics at the central server and at the remaining users would be updated to reflect the same change in panel no. 3. By contrast, if the user performs a change to a global property e.g. changes the hair color of one of the characters from blonde to black, the change would be propagated across all panels in the comic displayed at the user device, and after synchronization across all comics stored at the central server and comics displayed to other users, in which the object is included.

### Synchronization of Global Properties

There is a need to synchronize the global properties of assets, which are associated with authors or with the system, rather than with panels. For example, assuming that an author adds one of their characters to a panel, a character which has not previously been added to the comic. If the change data for the panel alone is transmitted to the other authors, the character could not be displayed accurately on other clients because, by default, the global data defining that character is not stored on the other clients.

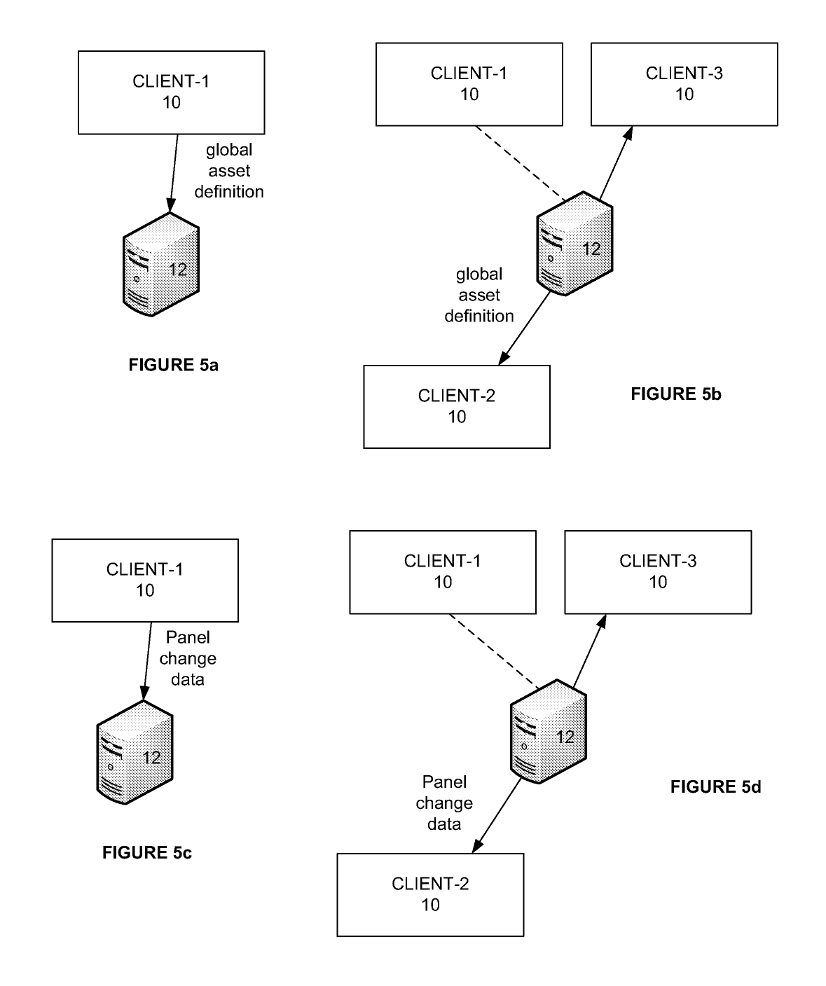

It is therefore necessary to synchronize the global data defining the character, prior to synchronizing the panel-specific data. FIGS. 5a to 5d illustrate the synchronization steps of global properties of assets, in accordance with an embodiment. With reference to FIGS. 5a to 5d, when the client 10 adds an asset to the panel, the global asset definition is sent to the shared data server 12, as shown in FIG. 5a. The global asset definition may then be sent to the other clients as shown in FIG. 5b. Each client 10 may then incorporate the global asset definitions of the new asset/character into the panel/comic. The client 10 may then send the panel change data to the shared data server 12 for the latter to forward the panel change data to the remaining clients 10 as exemplified in FIGS. 5c and 5d. Upon receipt of the panel change data, the clients may incorporate these to the panel/comic.

In an embodiment, the global properties of assets may be sent simultaneously with the panel change data or after the panel change data is sent, whereby the steps of FIGS. 5a and 5c may be done simultaneously and those of FIGS. 5b and 5d may also be done simultaneously.

Detection of new assets may be done in several ways. In one embodiment, the computing device used by the user introducing the new asset may detect the new asset and forward the global properties of the asset to the central server for storage and propagation. In another embodiment, the central server may detect the new asset in data received from one of the computing devices and request the global properties from the computing device associated with the new asset. In a third embodiment, the computing device of one the remaining users may detect the new asset and notify the central server to obtain the global properties of the new asset and forward these to the remaining users.

### Object Locking

If two or more authors change an object, such as a panel or a character, at about the same time, a potential conflict arises. In an embodiment, an object locking mechanism is implemented to mitigate this issue. In accordance with this embodiment, when an author begins making a modification to an object, an “object lock” (aka lock and momentary lock) event is automatically initiated and propagated to the other clients on the object that is being modified. As long as the lock is active on the other clients, the other clients cannot modify the locked object. In an embodiment, one or more users may be given the option to override or “steal” the lock. The lock status of an object may be indicated to the clients, such as by displaying a “lock” icon on the locked object. Alternatively, the lock may be invisible and the clients would know that the object is locked when they can no longer modify it.

In an embodiment, the lock may be applied at a number of hierarchical levels, for instance the lock may be applied to the object being modified; to the group of objects to which the object being modified belongs; or to the entire panel in which the object being modified occurs.

When the author has ceased making modifications to the object, indicated either by a lack of activity for some period of time, or by an explicit action on the part of the author modifying the object, an “unlock” event is initiated and propagated to the other clients.

Locks may be applied independently to panel-specific properties of assets, and/or to global properties of assets. For example, if an author is presently making changes to the looks of a character, a lock may be placed on the character's global properties, preventing other authors system wide from modifying that character's looks, until the lock has been released; however, authors are still free to modify the character's expression while the global property lock is active. If, on the other hand, an author is making changes to a character's expression, a lock may be placed on the character's panel-specific properties, preventing other authors within the team from modifying that character's expression within the same panel; however, authors are still free to modifying the character's looks, or the expression of the character in other panels or comics.

It should be noted that the lock and unlock events may be propagated from one client to the other clients following the same path as the synchronization events e.g. following the path shown FIGS. 5a and 5b.

### Commitment to Permanent Database

In an embodiment, when an author who is editing a panel saves the panel, the panel and the modifications are saved in the permanent database 14. The same applies to any object, such as a character or a comic.

The existence of a permanent database, which is separate from the shared data server, provides for two advantages:

1. The shared data server can be emptied of data, wholly or in part, without affecting the permanently saved comic data.

2. Authors can revert the data defining any object, to the previously saved state.

### Author Roles

In an embodiment, each author may be assigned one or more roles, e.g. “writer” or “background artist”. The functions and privileges associated to each author are dependent on the Role assigned to the author. Whereby, the scope of comic data that can be edited by the author is defined by the role of the author. For instance, an author with the role of “character artist” may be permitted to edit the global and panel-specific properties of characters, but not the other assets, such as speech bubbles and backgrounds.

In an embodiment, a permanent lock is placed on assets that the author does not have access to. By contrast to the momentary lock discussed above which is intended to mitigate synchronization conflicts, the lock used in the present embodiment is a permanent lock that prohibits authors from having access to data that they are not entitled to edit, and therefore, it is a permanent lock that does not unlock after a certain time as in the case of the momentary lock. Similar to the momentary lock, the permanent lock may be shown to the author or may be invisible.

Alternatively, a certain role may limit an author to edit only the panel-specific properties of characters, and not their global properties; or vice versa.

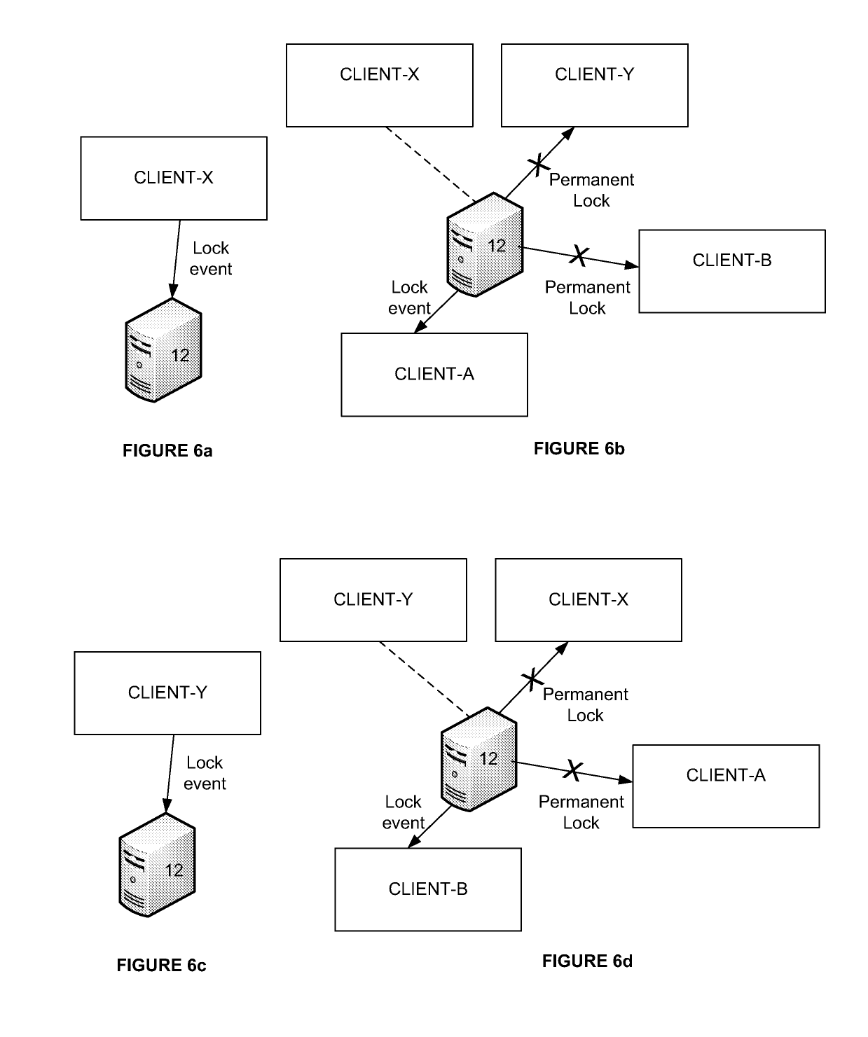

For example in situations when two authors X and Y with different roles are simultaneously editing the same panel, and the scope of their editing privileges do not overlap, an object lock (momentary lock) may not be generated from X to Y nor vice versa because the editing privileges associated with X and Y do not overlap. By contrast if other authors A and B are also collaborating on the comic and the editing privileges of A overlap with those of X and the editing privileges of B overlap with those of Y then an object lock may be generated between X and A, and between Y and B depending on who begun the editing first. An example is illustrated in FIGS. 6a to 6d.

In the example of FIGS. 6a to 6d, assuming that the editing privileges of clients X and A (as one group) and Y and B (as another group) do not overlap, while those of X and A overlap, and those of B and Y overlap as well. With reference to FIGS. 6a and 6b, if client X is a writer (and therefore has writer privileges) and is making modification to the speech bubbles in a certain panel, a momentary lock event is generated and forwarded to the shared data server 12 as shown in FIG. 6a. The momentary lock event is then sent to client A only and not to Y nor to B because there is no overlap in editing privileges between X and Y nor between X and B. In another embodiment, the momentary lock is sent to all active clients, however it is overridden by the permanent locks with Y and with B.

Similarly, if client-Y is a background artist (and therefore has background artist privileges), and is making changes background changes in the same panel, an object lock event is sent the shared data server 12 as shown in FIG. 6c. The shared data server 12 may then forward the object lock event to client B since Y and B have common editing privileges, but not to clients X and A since X and A have no editing privileges that are common with client Y. In another embodiment, the momentary lock is sent to all active clients, however it is overridden by the permanent locks with X and with A.

Needless to say, the object lock event is a momentary lock that is released after a certain time past the last change or manually by the client who begun the change. By contrast, the permanent lock between clients Y and B as one group of clients, and X and A as another group of clients is permanent, so long as the authors' roles remain unchanged. Whereby, client Y may edit the background of a certain panel and client X may edit the speech bubbles of the same panel simultaneously without any synchronization conflicts between the modifications of X and the modifications of Y.

In an embodiment, a list of all active users may be provided at the shared data server. The shared data server may cross reference the editing privileges associated with each user to create a list of users having overlapping/common editing privileges. When a given user begins to change a selected object in the comic, the momentary lock may be sent to all the users on the list to prevent them from modifying the same object and mitigate synchronization conflicts. The users on the list may continue to change other objects in the panel. Users outside the list may change data that the given user is not entitled to change. Whereby multiple users may work simultaneously on the panel including users with non-overlapping editing privileges, and users with overlapping editing privileges who may work on different objects of the same or different panels (when the object defines global properties), and/or users with overlapping editing privileges who may work on the same objects in different panels (when the object is panel specific).

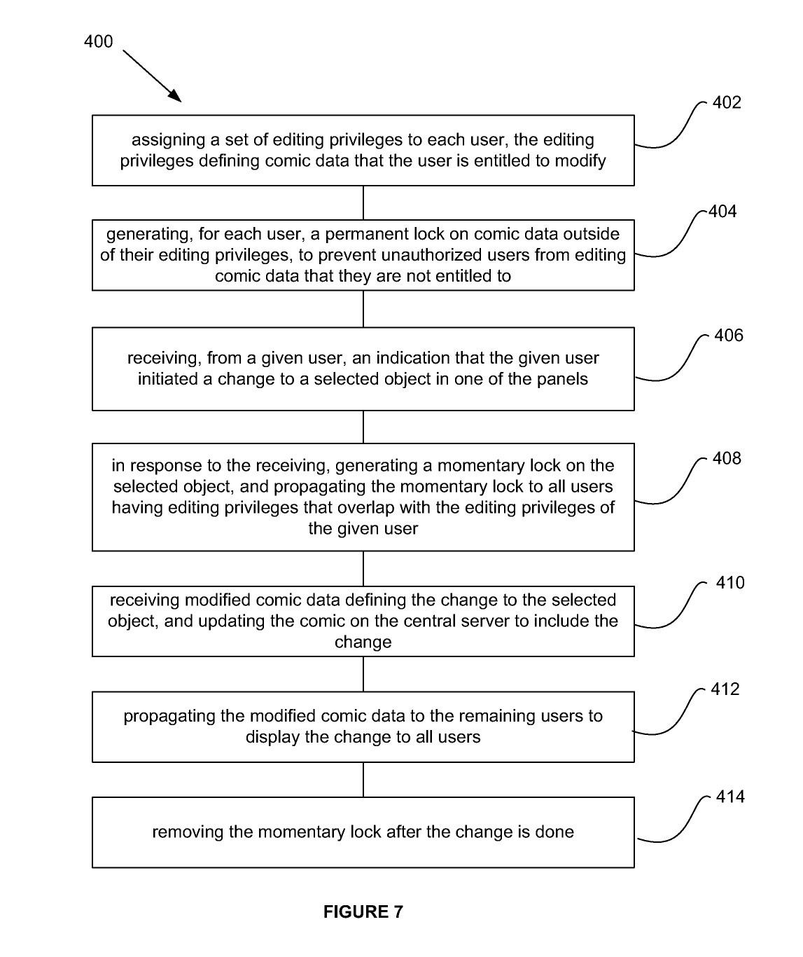

FIG. 7 is a flowchart of a method 400 for collaborative creation and editing of a comic by a plurality of users, each user using a computing device to access the comic from a central server over a communication network, the comic comprising one or more panels and each panel comprising one or more assets, in accordance with an embodiment. The method 400 begins at step 402 by assigning a set of editing privileges to each user, the editing privileges defining comic data that the user is entitled to modify. Step 404 comprises generating, for each user, a permanent lock on comic data outside of their editing privileges, to prevent unauthorized users from editing comic data that they are not entitled to. Step 406 comprises receiving, from a given user, an indication that the given user initiated a change to a selected object in one of the panels. Step 408 comprises, in response to the receiving, generating a momentary lock on the selected object, and propagating the momentary lock to all users having editing privileges that overlap with the editing privileges of the given user. Step 410 comprises receiving modified comic data defining the change to the selected object, and updating the comic on the central server to include the change. Step 412 comprises propagating the modified comic data to the remaining users to display the change to all users. Step 414 comprises removing the momentary lock after the change is done.

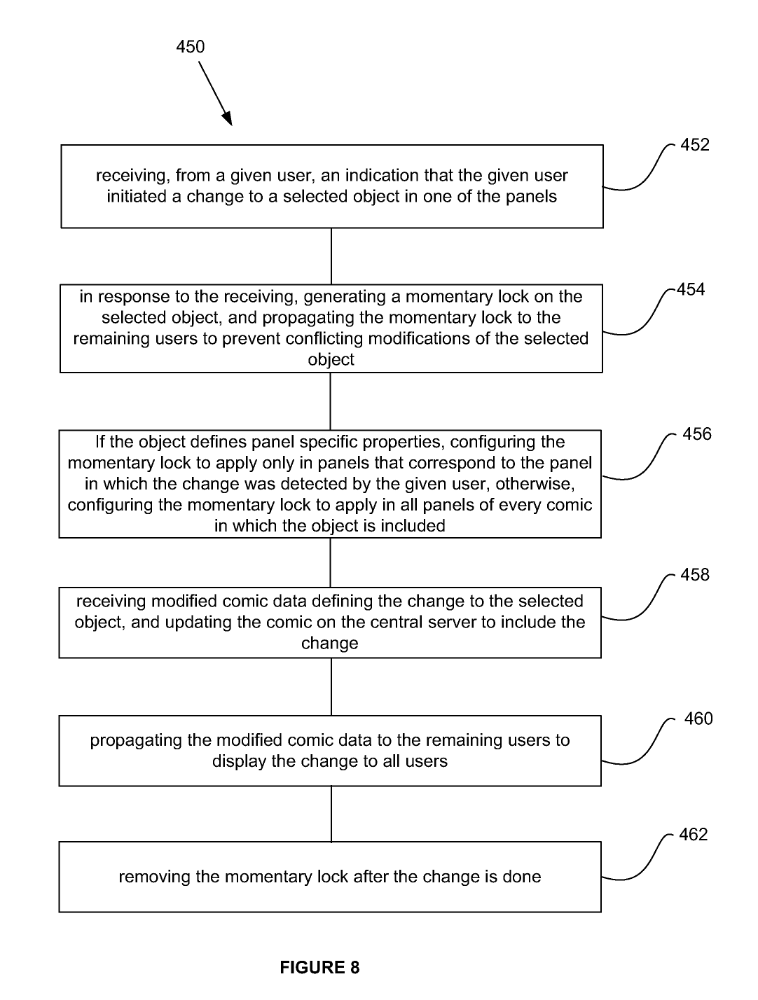

FIG. 8 is another flowchart of a method 450 for collaborative creation and editing of a comic by a plurality of users, in accordance with another embodiment. The method 400 begins at step 452 by receiving, from a given user, an indication that the given user initiated a change to a selected object in one of the panels. Step 454 comprises, in response to the receiving, generating a momentary lock on the selected object, and propagating the momentary lock to the remaining users to prevent conflicting modifications of the selected object. Step 456 comprises, if the object defines panel specific properties, configuring the momentary lock to apply only in panels that correspond to the panel in which the change was detected by the given user, otherwise, configuring the momentary lock to apply in all panels of every comic in which the object is included. For example, if there are few comic that are related to each other and include one or more common objects, if the global properties of one object are changed, the change is reflected in all the panels of the same comic, and also in all the panels of the related comics. For example, related comic may include different episodes, or different seasons of the same show. Step 458 comprises receiving modified comic data defining the change to the selected object, and updating the comic on the central server to include the change. Step 460 comprises propagating the modified comic data to the remaining users to display the change to all users. Step 462 comprises removing the momentary lock after the change is done.

### Computing Environment

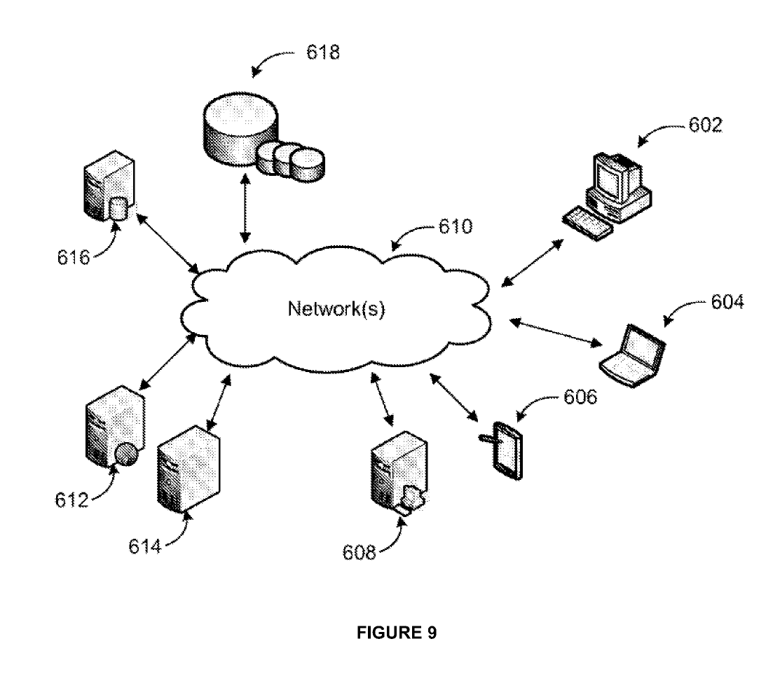

FIG. 9 is an example networked environment, where embodiments may be implemented. Extensible multi-tenant service systems may be implemented in a distributed manner over a number of physical and virtual clients and servers. They may also be implemented in un-clustered systems or clustered systems employing a number of nodes communicating over one or more networks (e.g. network(s) 610).

Such a system may comprise any topology of servers, clients, Internet service providers, and communication media. Also, the system may have a static or dynamic topology. The term “client” may refer to a client application or a client device. While a networked system implementing extensible multi-tenant services may involve many more components, relevant ones are discussed in conjunction with this Figure.

Requests for access may come from tenants using individual client devices 602-606 or application server 608 in a networked multi-tenant system. Such a system may also be implemented, in one or more servers (e.g. servers 612, 614) and accessed by the client devices (or applications). One or more web servers (physical or virtual) such as web server 612 may receive the requests and direct them to the appropriate resource. The resources may include scalable server clusters with synchronous and asynchronous server, organization databases, and other components.

Organization databases may be embodied in a single data store such as data store 618 or distributed over a number of data stores. Dedicated database servers (e.g. database server 616) may be used to coordinate data retrieval and storage in one or more of such data stores.

Network(s) 610 may include a secure network such as an enterprise network, an unsecure network such as a wireless open network, or the Internet. Network(s) 610 provide communication between the nodes described herein. By way of example, and not limitation, network(s) 610 may include wired media such as a wired network or direct-wired connection, and wireless media such as acoustic, RF, infrared and other wireless media.

Many other configurations of computing devices, applications, data sources, data distribution systems may be employed to implement an extensible multi-tenant service platform. Furthermore, the networked environments discussed in FIG. 9 are for illustration purposes only. Embodiments are not limited to the example applications, modules, or processes.

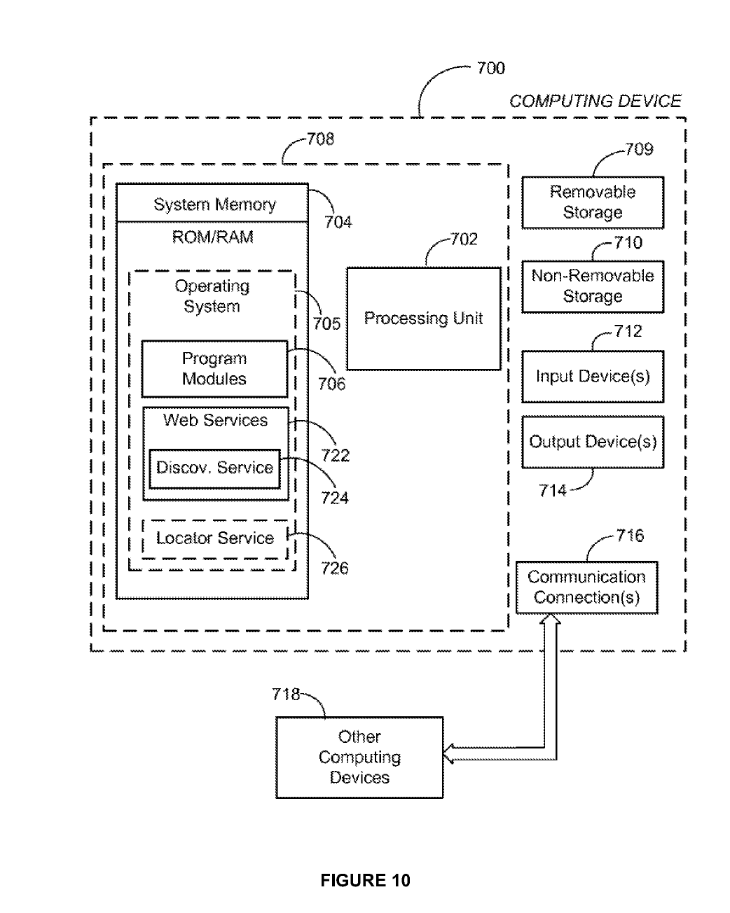

FIG. 10 and the associated discussion are intended to provide a brief, general description of a suitable computing environment in which embodiments may be implemented. With reference to FIG. 10, a block diagram of an example computing operating environment is illustrated, such as computing device 700. In a basic configuration, the computing device 700 may be a server providing management services associated with an extensible multi-tenant service and typically include at least one processing unit 702 and system memory 704. Computing device 700 may also include a plurality of processing units that cooperate in executing programs. Depending on the exact configuration and type of computing device, the system memory 704 may be volatile (such as RAM), non-volatile (such as ROM, flash memory, etc.) or some combination of the two. System memory 704 typically includes an operating system 705 suitable for controlling the operation of a networked personal computer, such as the WINDOWS® operating systems from MICROSOFT CORPORATION of Redmond, Wash. The system memory 704 may also include one or more software applications such as program modules 706, Web services 722, a discovery service 724 within web services 722, and an optional locator service 726.

Web services 722 may be a separate application or an integral module of a hosted multi-tenant service platform that provides data and processing services to client applications associated with computing device 700. Discovery service 724 may provide location and configuration information associated with individual organization (tenant) services to a client requesting access to those. Optional locator service 726 may provide services associated with determining a purpose of the service and which databases to use for web servers, as well as asynchronous processing servers, as described previously. This basic configuration is illustrated in FIG. 10 by those components within dashed line 708.

The computing device 700 may have additional features or functionality. For example, the computing device 700 may also include additional data storage devices (removable and/or non-removable) such as, for example, magnetic disks, optical disks, or tape. Such additional storage is illustrated in FIG. 10 by removable storage 709 and non-removable storage 710 Computer storage media may include volatile and nonvolatile, removable and non-removable media implemented in any method or technology for storage of information, such as computer readable instructions, data structures, program modules, or other data. System memory 704, removable storage 709 and non-removable storage 710 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 700. Any such computer storage media may be part of computing device 700. Computing device 700 may also have input device(s) 712 such as keyboard, mouse, pen, voice input device, touch input device, etc. Output device(s) 714 such as a display, speakers, printer, etc. may also be included. These devices are well known in the art and need not be discussed at length here.

The computing device 700 may also contain communication connections 716 that allow the device to communicate with other computing devices 718, such as over a wireless network in a distributed computing environment, for example, an intranet or the Internet. Other computing devices 718 may include server(s) that execute applications associated with a location service or other services. Communication connection 716 is one example of communication media. Communication media may typically be embodied by computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

The claimed subject matter also includes methods. These methods can be implemented in any number of ways, including the structures described in this document. One such way is by machine operations, of devices of the type described in this document.

While preferred embodiments have been described above and illustrated in the accompanying drawings, it will be evident to those skilled in the art that modifications may be made without departing from this disclosure. Such modifications are considered as possible variants comprised in the scope of the disclosure.

1. A method for collaborative creation and editing of a comic by users, each one of the users using a computing device to access the comic from a central server over a communication network, the comic comprising one or more panels and each panel comprising one or more assets, the method comprising:
assigning a set of editing privileges to each user, the editing privileges defining comic data that the user is entitled to modify;
generating, for each one of the users, a permanent lock on comic data outside of their editing privileges, to prevent unauthorized users from editing comic data that they are not entitled to;
receiving, from a given user, an indication that the given user initiated a change to a selected object in one of the one or more panels;
in response to the receiving, generating a momentary lock on the selected object, and propagating the momentary lock to all users having editing privileges that overlap with the editing privileges of the given user;
receiving modified comic data defining the change to the selected object, and updating the comic on the central server to include the change;
propagating the modified comic data to remaining ones of the users to display the change to all users; and
removing the momentary lock after the change is done.

2. The method of claim 1, further comprising applying the momentary lock only in the one or more panels that correspond to the panel in which the change is being performed by the given user, if the selected object defines panel specific properties.

3. The method of claim 1, further comprising applying the momentary lock in all the one or more panels of the comic, if the selected object defines global properties.

4. The method of claim 1, further comprising updating the comic to reflect the change only in the one or more panels that correspond to the panel in which the change is being performed by the given user, if the selected object defines panel specific properties.

5. The method of claim 1, further comprising updating the comic to reflect the change across all relevant panels of the comic, if the selected object defines global properties.

6. The method of claim 1, further comprising:
at the central server, detecting addition of a new asset by one of the users;
obtaining global properties of the new asset from the user associated with the new asset;
forwarding the global properties of the new asset to the remaining ones of the users for updating the comic on the computing device of each one of the users.

7. The method of claim 1, further comprising:
providing computer readable instructions for execution on the computing device of each one of the users upon login for displaying the comic on the computing device of each one of the users.

8. The method of claim 7, wherein the computer readable instructions cause the computing device to detect incorporation of a new asset into the comic and send global properties defining the new asset to the central server, the method further comprising:
upon receiving the global properties defining the new asset from one user, forwarding the global properties of the new asset to the remaining ones of the users; and
updating the comic centrally to add the new asset to the comic.

9. The method of claim 7, wherein the computer readable instructions cause the computing device to detect a new asset in comic data received from the central server, and notify the central server of data relating to the new asset, the method further comprising:
requesting global properties of the new asset from the user associated with the new asset;
receiving the global properties at the central server; and
forwarding the global properties of the new asset to the remaining ones of the users.

10. The method of claim 7, wherein the computer readable instructions are embedded in a web-browser installed on the computing device of each one of the users.

11. A server for collaborative creation and editing of a comic by users accessing the comic over a communication network, each one of the users using a computing device, the comic comprising one or more panels and each panel comprising one or more assets, the server comprising:
a processor having access to statements and instructions which when executed cause the processor to assign to each user a set of editing privileges defining comic data that the user is entitled to modify, and generate for each one of the users a permanent lock on comic data outside of their editing privileges;
a data input adapted to receive, from a given user, an indication that the given user initiated a change to a selected object in one of the one or more panels, and modified comic data defining the change to the selected object; wherein upon receiving the indication from the given user, the processor generates a momentary lock on the selected object;
a data output adapted to propagate the momentary lock to all of the users having editing privileges that overlap with the editing privileges of the given user to prevent conflicting modifications of the selected object, and to propagate the modified comic data to remaining ones of the users to display the change to all users; and
a memory for storing and updating the comic.

12. The server of claim 11, wherein the momentary lock is removed after the change is done.

13. The server of claim 11, wherein the editing privileges are grouped under roles, whereby users with different roles may work simultaneously on the same panel of the same comic.

14. The server of claim 11, wherein the momentary lock is applied only in panels that correspond to the panel in which the change is being performed by the given user, if the selected object defines panel specific properties.

15. The server of claim 11, wherein the momentary lock is applied in all the one or more panels of the comic, if the selected object defines global properties.

16. The server of claim 11, wherein the comic is updated to reflect the change only in the one or more panels that correspond to the panel in which the change is being performed by the given user, if the selected object defines panel specific properties.

17. The server of claim 11, wherein the comic is updated to reflect the change across all of the one or more panels of the comic, if the selected object defines global properties.

18. The server of claim 11, wherein the processor is adapted to detect an addition of a new asset by one of the users, obtain global properties of the new asset from the user associated with the new asset; and forward the global properties of the new asset to the remaining ones of the users for updating the comic on the computing device of each one of the users.

19. The server of claim 11, wherein the server is adapted to provide computer readable instructions for execution on the computing device of each one of the users for displaying and manipulating the comic on the computing device of each one of the users, wherein the computer readable instructions cause the computing device on which they are installed to detect incorporation of a new asset in one of the one or more panels, and send global properties defining the new asset from the computing device to the server.

20. A method for collaborative creation and editing of a comic by users, each user using a computing device to access the comic from a central server over a communication network, the comic comprising one or more panels and each panel comprising one or more assets, the method comprising:
receiving, from a given user, an indication that the given user initiated a change to a selected object in one of the one or more panels;
in response to the receiving, generating a momentary lock on the selected object, and propagating the momentary lock to remaining ones of the users to prevent conflicting modifications of the selected object;
if the selected object defines panel specific properties, configuring the momentary lock to apply only in panels that correspond to the panel in which the change was detected by the given user, otherwise, configuring the momentary lock to apply in all panels of every comic in which the object is included;
receiving modified comic data defining the change to the selected object, and updating the comic on the central server to include the change;
propagating the modified comic data to the remaining ones of the users to display the change to all users; and
removing the momentary lock after the change is done.
